(19) United States
(12) Patent Application Publication
(10) Pub. No.: US 2021/0022339 A1
(43) Pub. Date: Jan. 28, 2021

(54) USE OF DELAYED DORMANT APPLICATIONS OF HOMOBRASSINOLIDE ON GRAPES TO ENHANCE BUD BREAK

(71) Applicant: Naga Bhushan Mandava, Potomac, MD (US)

(72) Inventor: Naga Bhushan Mandava, Potomac, MD (US)

(21) Appl. No.: 16/936,772

(22) Filed: Jul. 23, 2020

Related U.S. Application Data
(60) Provisional application No. 62/877,402, filed on Jul. 23, 2019.

(51) Int. Cl. A01N 43/22; A01N 45/00

(52) U.S. Cl. CPC A01N 43/22; A01N 45/00

(57) ABSTRACT

We disclose methods to enhance bud breaking in grapes. Unfavorable bud breaking is caused by insufficient dormancy, which itself is commonly caused by insufficiently cold or long winters. Insufficient dormancy results in apical dominance which lessens the number of branches and fruiting sites. We have discovered that treatment with the plant growth regulator homobrassinolide enhances great growth uniformity and bud-break uniformity similar to Hydrogen Cyanamide without the negative effects.

### FIELD OF THE INVENTION

The subject matter of this application pertains to a method for using Plant Growth Regulators (PGRs) to improve certain desired characteristics of grapes including bud break, uniform shoot growth, and uniform fruit growth. More precisely, the subject matter of this application pertains to methods of improving certain desired characteristics of grapes including bud break, uniform shoot growth, and uniform fruit growth. with the use of homobrassinolide (CAS #80483-89-2).

### BACKGROUND

Grapes have been domesticated since perhaps as early at 6,000 BC. They can be enjoyed freshly picked from the vine or made into jams, jellies, or extracts. They can be processed into grape seed oil or dried to become raisins. Grape skin is an attractive substrate for wild yeasts which leads to to the grape's highest calling: wine.

A grape is a berry of the deciduous woody vines from the flowering plant genus Vitis. The seedless variety now dominates the majority of table grapes due to the main propagation method of grapes being done by cuttings. The Thompson seedless variety also known as sultana grapes are a white (pale green) variety of grapes that are commonly eaten plain in addition to being used for raisins and in the production of wine. It is the most cultivated grape in California due to its wide range of usages.

According to the 2016 report “Table and Dried Grapes,” published by Food and Agriculture Organization fo the United Nations and the International Organization of Vine and Wine (http://www.fao.org/3/a-i7042e.pdf) grapes are one of the world largest fruit crops with approximately 75 million tonnes (75 billion kilograms) produced each year worldwide.

In woody perennials, bud dormancy is an intricate process that protects plants in response to abiotic stress. Seasonal environmental changes adopted by woody perennials during dormancy promote their survival under unfavorable conditions and ensure simultaneous blooming in the orchard which improves fruit production. A period of low temperature often termed as “winter chilling” is required in temperate perennial species for the bud breaking of plants from endodormancy. The grape starts its annual growth cycle in the spring with bud breaking. Bud breaking occurs after the vine has been pruned over the winter and the soil begins to warm causing osmotic forces to push water with small concentrations of plant hormones, minerals and sugars up the root system. They are expelled from the cuts left from pruning. This “bleeding” of the vine signals the buds to begin swelling which develops into shoots. Insufficient chilling generally results in non-uniform flowering and reduced fruit set. Therefore, to allow coordinated and early production of economically viable yields, artificial chemicals have been used to avoid prolonged dormancy. Improving bud break is crucial due to the insufficient chilling that occurs in many parts of the world. (J. Robinson (ed) “The Oxford Companion to Wine”Third Edition pg 741-742 Oxford University Press 2006)

Shoot growth and apical dominance determines the characteristic shape and size of deciduous plants and the effects on lateral growth. The amount of rest affects apical dominance, particularly when there is insufficient dormancy. Apical dominance is the phenomenon whereby the main, central stem of the plant grows more strongly than other side stems. Growth of lateral buds is controlled by the terminal bud, which produces auxin a growth hormone. Auxin moves downward in the shoot from the apex and inhibits the growth and development of lateral buds by diverting sugars away from the buds. The shoot growth on vertical limbs can be so vigorous near the terminal bud that lateral shoots become very sparse. This leads to subsequent yield reductions which becomes detrimental to farmers and growers. (Nito, N., & Kuraishi, S. (1979). Abnormal auxin distribution and poor berry setting (coulure) in grapes. Scientia Horticulturae, 10(1), 63-72. doi:10.1016/0304-4238(79)90070-0)

The plant growth regulator Hydrogen Cyanamide (Tradename: Dormex®) is typically applied to grapes pre-bud break under conditions of sub-optimal winter chilling to increase yield and flowering time, because Dormex increases the yield of fruits in environments not typically suited for them. However, The Department of Pesticide Regulation of the California EPA studied the effects of Hydrogen Cyanamide (HC) and concluded that HC causes adverse effects in the liver, thyroid, kidney, ovaries, and testes of laboratory animals. EPA further stated that in the absence of additional data to the contrary, HC has the potential to cause similar effects in humans.

Brassinosteroids (“BRs”) are important steroid plant growth regulating hormones. that are found throughout the plant kingdom and have unique growth promoting activity when applied exogenously to plants (Mandava, N. B. Plant growth promoting brassinosteroids. Annual Review of Plant Physiology and Plant Molecular Biology 1988, 39; 23-52). BRs are reported to increase yields and improve stress resistance of several crop plants (Cutler, H. G., et. al.. Brassinosteroids: chemistry bioactivity, and applications. ACS symposium Series 474. Washington DC, 1991; American Chemical Society). Brassinosteroids are known to enhance both cell division and cell elongation; elicit profound physiological responses at concentrations as low as 10⁻²³ M; interact synergistically with other PGRs; elicit responses mostly in meristematic tissues; and control the growth and development of crops in a tissue specific and organ specific manner. Treatments with BRs are effective ways of increasing yield of many crops even in cases of drought, extreme temperatures, and improper soil salinity. For example, in almond trees, BRs have been shown to counteract the slowed pollen tube growth rate caused by lower temperatures (Bernard, D. and Socias, R. I Company. Characterization of Some Self-compatible Almonds. II. Flower Phenology and Morphology. HortScience, 1995, 30(2): 321-324).

Brassinolide, the first identified brassinosteroid, was first isolated in 1979 from rape (Brassica napus L.) pollen, where it is present in quantities up to 200 parts per billion. The first chemical synthesis of brassinolide (BL) was achieved in 1979. Since then a number of BL analogs have been synthesized. This research has led to the discovery of two most active brassinolide (BL) analogs: 24-epibrassinolide (EBR) and homobrassinolide (HBR) which are naturally occurring and more financially viable for commercial applications than BL. These BRs can be synthesized from widely available commercial plant sterols with reasonable yields. The direct biological precursor of homobrassinolide is homocastasterone which will also enhance uniformity and bud break due to its possession of the same vicinal 22R, 23R diol structural functionality which are essential for the physiological activities of homobrassinolide.

Inventions inducing or improving bud break without the use of hydrogen cyanamide have been brought to the public such as those described in U.S. Pat. No. 9,938,200, and U.S. Patent Applications 20160016859 and 20120060573. These disclosures involve the use of nitrogen, phosphorus, potassium, calcium, magnesium, trace elements, acidifier, fulvic acid, and seaweed to compensate for the mineral deficiencies that might occur during bud dormancy as a result of insufficient chilling.

With the development of methods to synthesize BRs, exogenous applications of these PGRs have become an increasingly feasible method for crop quality optimization. In the following account of studies, exogenous applications of HBR were used to determine its effects on bud break and uniformity.

### SUMMARY

An objective of the subject matter of this application is to provide methods for preventing unfavorable bud breaking. A further objective of the subject matter of this application is to prevent unfavorable bud breaking caused by insufficient dormancy. Yet a further objective of the subject matter of this application is to provide methods for preventing unfavorable bud breaking due to insufficient dormancy which do not include Hydrogen Cyanamide.

Insufficient dormancy and the resulting unfavorable bud breaking leads to apical dominance which in turn leads to the majority of auxin being produced in the vertical shoots which causes lateral shoots to become very sparse. The solution to this will be achieved through increase of auxin response in the lateral buds allowing for more vigorous growth of the lateral buds increasing the number of shoots thus leading to a more uniform growth.

In order to achieve this, this invention provides a plant growth regulator for Thompson Seedless Grapes which is comprised of Homobrassinolide 0.1% (1 g ai/L) SC and Latron B1956 surfactant. The main component is Homobrassinolide which works with auxin to promote cell expansion and elongation acting as a potentiator increasing auxins response playing a role in cell division, cell regeneration, promotion of vascular differentiation, and elongation of the pollen tube. Brassinosteroids also increases the sugar available for the growth of lateral buds allowing for more uniform growth. Application of HBR was shown to enhance fruit growth uniformity and bud break uniformity.

### BRIEF DESCRIPTION OF THE FIGURES

FIG. 1 is the chemical structure of homobrassinolide.

FIG. 2 is the chemical structure of brassinolide.

FIG. 3 is the chemical structure of epibrassinolide.

FIG. 4 is the chemical structure of castasterone.

FIG. 5 is the chemical structure of 28-homocastasterone.

FIG. 6 is a table of results of homobrassinolide trials on bud break uniformity.

FIG. 7 is a chart illustrating the effects of homobrassinolide on bud break uniformity.

### DETAILED DESCRIPTION OF THE SUBJECT MATTER

The following description and referenced figures illustrate embodiments of the subject matter of this application. They are not intended to limit the scope of the claims. Those familiar with the art may recognize that other embodiments of the disclosed method are possible. All such alternative embodiments should be considered within the scope of the application's claims.

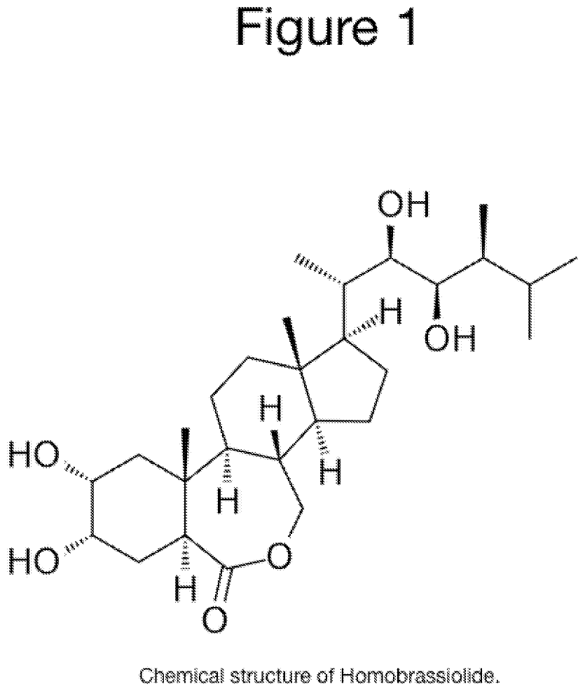

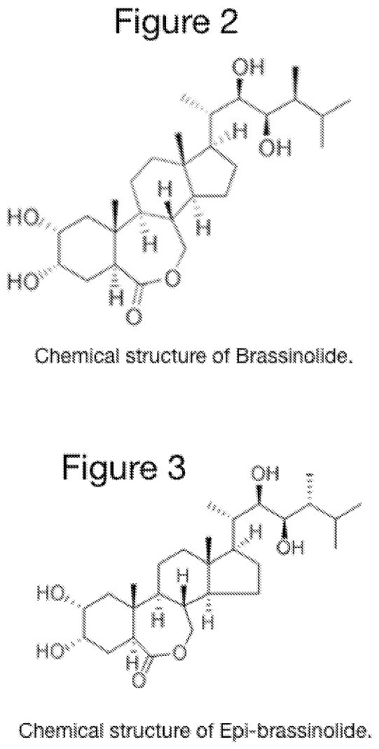

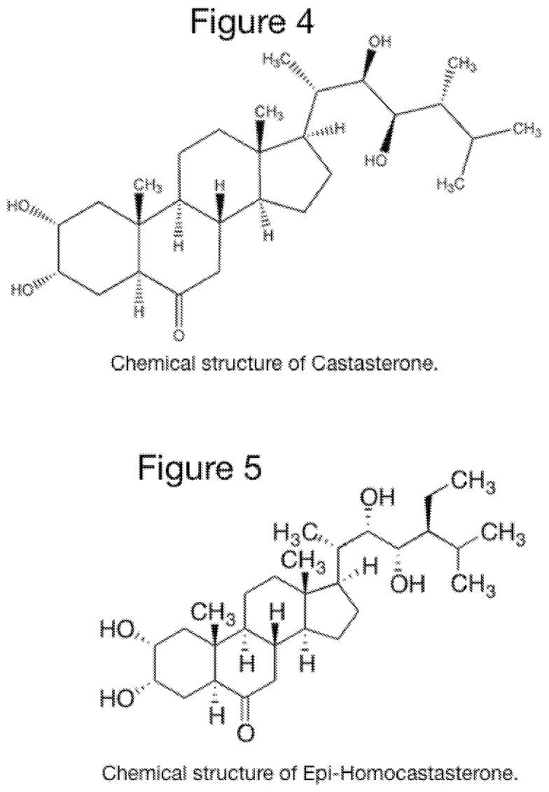

Applicant discloses methods of using homobrassinolide (“HBR” FIG. 1) as a rest breaking agent comparable to Hydrogen Cyanamide in efficacy. HBR can be applied dormant and delayed dormant without crop injury. Delayed dormant application allows the deciduous crop to accumulate maximum chilling, which is particularly useful in years of warm winters. Other related plant growth regulating molecules such as brassinolide (FIG. 2), epibrassinolide (FIG. 3), castasterone (FIGS. 4), and 28-homocastasterone (FIG. 5) are hypothesized to have similar efficacy.

A portion of an established commercial vineyard was used for the study. The HBR (FIG. 1) treatments were replicated down a single row and arranged in sets of 3 vines per plot. Plots were flagged with colored ribbon to identify the treatments and there were 4 replicates each. Spray applications were made when the vines were still dormant on Day 0 (Feb. 12, 2019) or during the delayed dormant period, when buds were swollen or at eraser stage, on Day 24 (Mar. 8, 2019)). Specific details on the spray applications and a test site description are shown in Table 1. Fruit and foliage were observed for symptoms of phytotoxicity periodically during the trial at each evaluation interval. Crop injury was rated using a scale of 0-10, where 0=no injury and 10=100% of tree injured. Percentage bud break was evaluated by counting numbers of shoots from 30 nodes on fruiting canes from trunk to trunk and 5 renewal spurs were chosen non-systematically on Day 34 (Mar. 18, 2019) and Day 41 (Mar. 25, 2019).

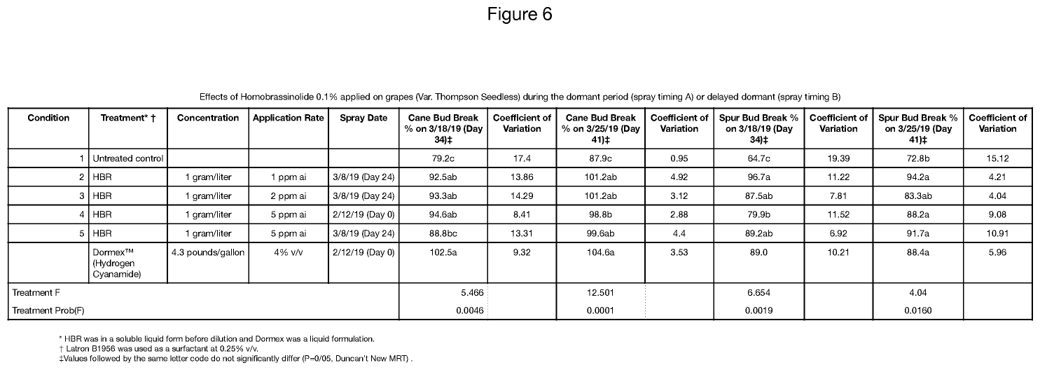

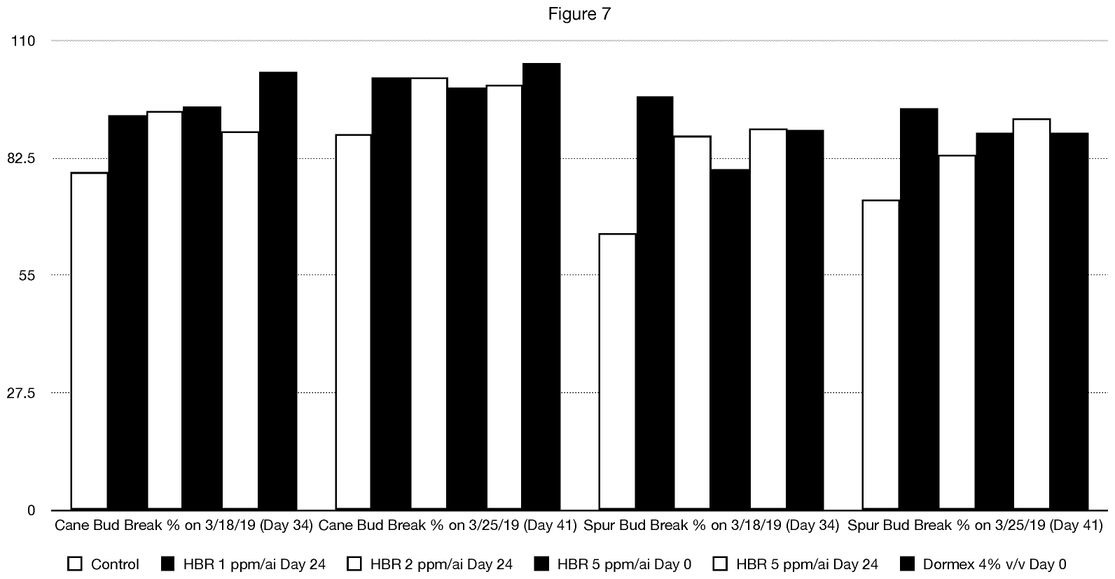

Statistical differences were highly significant and variability in the data was low. Having waited until approximately 55 chill portions (a quantification of the aggregate low temperature exposure needed for a crop to break dormancy), the dormant sprays allowed both the Hydrogen Cyanamide (Dormex®) treated and untreated vines to accumulate the maximum chilling. HBR at label rates of 1 part per million active ingredient (“ppm ai”) and 2 ppm ai applied at early bud swell was as effective as the standard rate of Dormex or 5 ppm ai HBR applied in the dormant period compared to the untreated check. HBR applied delayed dormant at 5 ppm appeared to have been too high based on effects being statistically equivalent to the untreated check 34 days after application (“DAA”). By 41 DAA, bud break in plots treated with the rest breaking agents had peaked and were statistically greater than the untreated check, which did not reach 100% bud break. Uniformity was enhanced by both Dormex® and 5 ppm ai HBR applied as a dormant spray. Variability was lowest in the untreated check by 41 DAA even though bud break had not reached 90%. It is not unusual for bud break to exceed 100% because secondary shoots were stimulated by the effects of overcoming apical dominance by both effective rest breaking and the accumulation of maximum chilling by untreated vines. FIGS. 6 and 7.

Effects on spur bud break were not as strong as observed on fruiting canes and did not reach 100% by 41 DAA in any treatment, including the Dormex® standard treatment. However, the results were statistically significant between the rest breaking treatments as a group compared to the untreated check at both evaluation intervals. In addition, by 41 DAA, the effects of 2 ppm ai HBR applied at bud swell were also equivalent to the untreated check. It appeared that spur bud break had peaked by 34 DAA because by 41 DAA, percentages were mostly the same. Only the untreated check continued to break buds, which remained approximately 15% lower than the rest breaking treatments as a group.

Treatment with homobrassinolide also increased number of shoots by overcoming apical dominance from either dormant or delayed dormant spray applications.

HBR treatments of 1 ppm ai, 2 ppm ai, or 5 ppm ai increased shoots compared to control and both 1 ppm ai and 1 ppm ai treatments were comparable to the Hydrogen Cyanamide standard treatment.

Treatment with HBR has several advantages to the standard Hydrogen Cyanamide treatment:

1. Dormex (Hydrogen Cyanamide) is a synthetic chemical with reported toxicity due to acute exposure while HBR is a naturally occurring plant hormone with a non-toxic mode of action.

2. HBR is biodegradable, leaves no residue, and is environmentally safe (Source: label for 0.1% HBR) whereas Hydrogen Cyanamide is not readily biodegradable (Source: SDS from Alzchem).

3. As disclosed in the specification, HBR is active in the nano molar to pico molar range, whereas approximately 20,000 times the amount of Hydrogen Cyanamide is needed approach the effect of HBR.

4. Repeated use of Hydrogen Cyanamide over the years can lower the fruitability of vines by as much as 20-30% per year whereas HBR has no such effect. See US2016016859 paragraph 008. HBR has been shown to improve plant stress tolerance, flowering, fruit growth, and overall quality of crops. Repeated use of HBR may cause stress thus affecting the crop yield.

5. Dormex can damage nearby crops whereas there is no evidence that HBR has harmful effects on nearby crops (https://journals.ashs.org/horttech/abstract/journals/horttech/26/6/article-p839.xml)

6. HBR also has multiple biological actions besides enhancing bud breaking that are often desired such as enhanced ripening, fruit firmness, and disease resistance.

7. Dormex can be phytotoxic in grapes and other fruit crops whereas HBR has been found to be non-phytotoxic. Dormex can be acutely toxic when misused.

We claim:

1. A solution for enhancing bud break in plants comprising a plant growth regulator selected from the group consisting of Homobrassinolide, brassinolide, epibrassinolide, castasterone, and 28-homocastasterone.

2. The solution of claim 1 in which said the concentration of the plant growth regulator is between 1 part per million and 2 parts per million.

3. A method for enhancing bud break in plants comprising the steps of treating plants following delay dormant stage with a solution comprising a plant growth regulator selected from the group consisting of Homobrassinolide, brassinolide, epibrassinolide, castasterone, and 28-homocastasterone at a concentration of between 1 part per million and 2 parts per million.

4. A method for enhancing bud break in plants comprising the steps of treating plants at bud swell stage with a solution comprising a plant growth regulator selected from the group consisting of Homobrassinolide, brassinolide, epibrassinolide, castasterone, and 28-homocastasterone at a concentration of between 1 part per million and 2 parts per million.

5. The solution of claim 1 in which the plant growth regulator is homobrassinolide.

6. The solution of claim 1 in which the solution is comprised of 1-2 ppm homobrassinolide.

7. The method of claim 3 in which the plant growth regulator is homobrassinolide.

8. The method of claim 3 in which the solution is comprised of 1-2 ppm homobrassinolide
